(19) United States
(12) Patent Application Publication
(10) Pub. No.: US 2016/0278191 A1
(43) Pub. Date: Sep. 22, 2016

(54) ANTISTATIC SHEET

(71) Applicant: SEKISUI PLASTICS CO., LTD., Osaka-shi, Osaka (JP)

(72) Inventors: Kazuki KATO, Inashiki-gun (JP); Yasuhiro FUJIWARA, Inashiki-gun (JP)

(73) Assignee: SEKISUI PLASTICS CO., LTD., Osaka-shi, Osaka (JP)

(21) Appl. No.: 14/778,418

(22) PCT Filed: Mar. 20, 2014
(86) PCT No.: PCT/JP2014/057734

§ 371 Date: Sep. 18, 2015

(30) Foreign Application Priority Data
Mar. 29, 2013 (JP) 2013-071330

(51) Int. Cl. H05F 1/02

(52) U.S. Cl. CPC H05F 1/02

(57) ABSTRACT

An antistatic sheet capable of improving working efficiency includes a laminated body formed by laminating a polymer gel on an antistatic-treated base sheet, the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; water having dissolved therein at least polyvinyl alcohol-type polymer; and a polyhydric alcohol other than polyvinyl alcohol-type polymer, wherein the water and the polyhydric alcohol are retained in the polymer matrix, the antistatic sheet having a ground resistance of 1.0×10⁵Ω or more and 1.0×10¹²Ω or less, and a surface resistivity of 1.0×10⁴Ω/□ or more and 1.0×10¹²Ω/□ or less as measured with respect to a surface thereof on a side of the base sheet.

### TECHNICAL FIELD

The present invention relates to an antistatic sheet used for operations requiring measures to protect electronic parts from static electricity, such as semiconductor production process performed in a clean room.

### BACKGROUND ART

A semiconductor device, a glass of an organic EL device, etc. may suffer the problem of damage or malfunction from electrostatic discharge. Especially, the electrostatic discharge during the production of such devices has a serious impact on the yield of very precise and expensive products; therefore, the countermeasures against static electricity are essential in the production environment. Further, IEC61340-5-115-2, a standard of the IEC (International Electrotechnical Commission), strictly stipulates the surface resistance (surface resistivity) and the point-to-point resistance (ground resistance), which has led to the recent inclination toward the use of static dissipative materials.

The main causes of the static electricity include 1) inflow of static electricity from outside, and 2) self-discharge of the products due to frictional electrification and the like. The inflow of static electricity from outside is largely due to the electrical charge of human body, which can be considerably alleviated by attaching a wrist strap to a human wrist.

On the other hand, the countermeasures against the self-discharge include grounding (earthing) a working platform for processing the products, ii) humidifying the work space, iii) ion-spraying the products by a static eliminator such as an ionizer, and iv) applying antistatic spray to a work mat for placing the products thereon and the like. However, these countermeasures have their respective problems. Specifically, the grounding (earthing) is applicable only to conductors such as metals and is not effective for insulating materials such as glass. The humidification of the working environment is accompanied by a risk of contaminating the products by the moisture. The use of an ionizer does not have a satisfactory effect as a countermeasure against the local occurrence of static electricity. The spraying of a work mat and the like is simple and easy, but is accompanied by a problem of drying and contamination of the product surface and a problem of poor durability of the resulting coating.

Therefore, in many cases, the working environment is covered with a conductive material as a countermeasure against the static electricity from a comprehensive perspective while taking into consideration the respective problems of the aforementioned countermeasures.

As an example of the conductive material, International Patent Application Publication No. 2011/155492 (Patent Document 1) proposes an antistatic coating PET. This film is uniformly coated on its surface with an antistatic agent and, therefore, can suppress the surface resistivity to a low level. However, the film has no grounding effect, so that the film does not meet the specification of the standard of IEC. Further, the film needs to be fixed by an adhesive tape or the like to a surface on which an operation is performed, and is likely to be electrically charged due to non-uniformity in contact area caused when a gap is left between the film and the contact surface of a working platform.

Japanese Patent Application Unexamined Publication No. 10-114886 (Patent Document 2) discloses an adhesive tape having an antistatic layer. However, such an adhesive tape has poor releasability and, therefore, is likely to contaminate the surface of the working platform or deteriorate the working efficiency. Further, the adhesive tape has disadvantages that the resistivity is too large to provide satisfactory antistatic effect, and the adhesive tape is very thin and has no cushioning effect.

Japanese Patent Application Unexamined Publication No. 2010-275504 (Patent Document 3) proposes a method in which an antistatic floor mat is prepared by coating a polyvinyl chloride mat with a conductive ink such as carbon black.

However, this method has a problem concerning dispersion stability of conductive filler used, which results in occurrence of portions with a locally high or low surface resistivity, thereby creating an environment where a current flow is likely to be established when the mat is contacted with materials charged at different levels. Further, the color of the mat does not allow to see through to the bottom of the mat; therefore, it is difficult to visually observe the operation being performed.

### PRIOR ART REFERENCES

### Patent Document

Patent Document 1; International Patent Application Publication No. 2011/155492

Patent Document No. 2: Japanese Patent Application Unexamined Publication No. 10-114886

Patent Document 3: Japanese Patent Application Unexamined Publication No. 2010-275504

### DISCLOSURE OF INVENTION

### Problems to be Solved by the Invention

In this situation, the present invention has been made as a result of extensive and intensive studies toward solving the problems encountered in the conventional countermeasures against static electricity in the semiconductor production process and the like, and the objects of the present invention are to provide a product capable of improving the working efficiency at the site of production, as well as to attempt to realize, improve and stabilize the antistatic performance of the product.

### Means to Solve the Problems

In order to achieve the aforementioned objects, the following inventions are provided.

Specifically, there is provided an antistatic sheet comprising a laminated body formed by laminating a polymer gel on an antistatic-treated base sheet, the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; water having dissolved therein at least polyvinyl alcohol-type polymer; and a polyhydric alcohol other than polyvinyl alcohol-type polymer, wherein the water and the polyhydric alcohol are retained in the polymer matrix, the antistatic sheet having a ground resistance of 1.0×10⁵Ω or more and 1.0×10¹²Ω or less, and a surface resistivity of 1.0×10⁴Ω/□ or more and 1.0×10¹²Ω/□ or less as measured with respect to a surface thereof on a side of the base sheet.

Due to the use of the polymer gel, the antistatic sheet of the present invention can be easily attached and fixed to a working platform, a transfer carrier or a table, which is difficult in the case of independent use of the base sheet alone, and the antistatic sheet can be easily removed from an adherend. Further, due to the use of the specific polymer gel which exhibits self-adhesive property, the antistatic film can be easily fixed to an adherend such as a working platform and can be removed from the adherend without leaving an adhesive polymer gel on the adherend. The specific polymer gel comprises: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; water having dissolved therein at least polyvinyl alcohol-type polymer; and a polyhydric alcohol other than polyvinyl alcohol-type polymer, wherein the water and the polyhydric alcohol are retained in the polymer matrix. Therefore, the antistatic film can be easily attached to and removed from an adherend without contaminating the adherend, and can be used for various purposes.

Further, since such a polymer gel and an antistatic-treated base sheet are laminated in the antistatic sheet of the present invention, the thickness of the base sheet or the polymer gel can be easily changed, whereby the hardness or feel of the antistatic sheet can be easily controlled in accordance with the intended use of the antistatic sheet. For example, when the antistatic sheet is used as a mat to be placed on a working platform or a conveying carrier, or as a wall material, the antistatic sheet can be designed to have a high hardness. When the antistatic sheet is used as a cover for a keyboard of a personal computer, the antistatic sheet can be designed to be soft. Thus, the antistatic sheet can be readily used for various different purposes.

The combination of the electrical conductivity of the polymer gel and the antistatic-treated base sheet enables to control the resistance. The surface resistivity of the antistatic sheet can be easily controlled to be a value which is not too low or too high, and the ground resistance can also be controlled to fall within a predetermined range by the combination of the polymer gel and the base sheet.

The antistatic sheet may have a ground resistance of 1.0×10⁵Ω or more and 1.0×10¹²Ω or less, and a surface resistivity of 1.0×10⁴Ω/□ or more and 1.0×10¹²Ω/□ or less as measured with respect to a surface thereof on a side of the base sheet. The antistatic sheet can be used for providing at least minimum required countermeasures against static electricity when the antistatic sheet has a ground resistance of 1.0×10⁵Ω or more and 1.0×10¹²Ω or less, and a surface resistivity of 1.0×10⁴Ω/□ or more and 1.0×10¹²Ω/□ or less as measured with respect to a surface thereof on a side of the base sheet. The antistatic sheet may have a ground resistance of 1.0×10⁵Ω or more and less than 1.0×10⁹Ω, and a surface resistivity of 1.0×10⁴Ω/□ or more and less than 1.0×10⁹Ω/□. The antistatic sheet can satisfy the specification of the IEC standard when the antistatic sheet has a ground resistance of 1.0×10⁵Ω or more and less than 1.0×10⁹52, and a surface resistivity of 1.0×10⁴Ω/□ or more and less than 1.0×10⁹Ω/□.

The antistatic sheet may be a laminated body formed by providing an antistatic coating on one side of the base sheet, and laminating a polymer gel on another side of the base sheet. The surface resistivity of the antistatic sheet can be readily controlled to fall within a desired range when the antistatic coating is provided on a side of the base sheet opposite to a side on which the polymer gel is laminated. Further, in this case, the ground resistance of the laminated body in which the base sheet and the polymer gel are laminated can be readily controlled to fall within a desired range.

In the antistatic sheet of the present invention, the polymer matrix of the polymer gel may be an acrylic polymer, and the surface resistivity of the polymer gel may be 1.0×10³Ω/□ or more and less than 1.0×10⁹Ω/□.

When the polymer matrix of the polymer gel is an acrylic polymer, it is easy to cause the polymer gel to contain water and to cause the polymer matrix to form a dense structure with the polyvinyl alcohol type polymer. Accordingly, the resulting antistatic film exhibits excellent removability such that the film can be removed without being fixedly adhered to or leaving a residual adhesive matter on an adherend. Further, the surface resistivity can be readily controlled to fall within a desired range. Furthermore, since the surface resistivity of the polymer gel is set at 1.0×10³Ω/□ or more and less than 1.0×10⁹Ω/□, the IEC standard can be met, and the ground resistance can be readily controlled to fall within a desired range as well.

In the antistatic sheet of the present invention, the polymer gel may have a C-type hardness of 5 to 80, a gripping force in a horizontal direction relative to SUS (“SUS” means a stainless steel plate and the same shall apply hereafter) is 5 N/(20 mm×120 mm) or more, and a peel strength for peeling from SUS is 1 N/20 mm or less.

When the C-type hardness of the polymer gel is in the range of 5 to 80, the antistatic sheet is not too hard and not too soft, so that the antistatic sheet can be favorably used as a mat to be placed on a working platform and the like. Further, when the gripping force in a horizontal direction relative to SUS is 5 N/(20 mm×120 mm) or more, and the peel strength for peeling from SUS is 1 N/20 mm or less, the antistatic sheet can be easily fixed to an adherend such as a working platform, and can be easily detached from the adherend when the removal of the antistatic film is intended. Thus, the antistatic sheet of the present invention has excellent usability.

The base sheet may be a transparent or white sheet of an olefin-type. When the base sheet is formed of an olefin-type resin, the surface resistivity can be readily controlled to fall within a desired resistivity range. Further, such a base sheet is unlikely to be scratched on its surface and unlikely to deteriorate over time.

Further, when the base sheet is transparent, the antistatic film of the present invention can be used in a manner such as would cover a key board of a personal computer or a surface of a working table, and it becomes possible to adjust the position under a table or to perform an operation while viewing materials such as an instruction sheet. On the other hand, when the base sheet is white, the appearance of the antistatic sheet can be improved.

The antistatic sheet as mentioned above can be favorably utilized for the situation and location where electronic parts need countermeasures against static electricity. For example, the antistatic sheet can be favorably used for providing countermeasures against static electricity during dicing process or glass polishing, or for various other purposes such as: a tabletop sheet to be placed on a working platform or a conveying stand in a clean room; a floor or wall material used in a clean room; a cover sheet for an operation board, a touch panel surface, a key board of a personal computer, or the like.

### Effect of the Invention

The antistatic sheet of the present invention has excellent antistatic performance, and can be easily attached to and removed from an adherend such as a working platform in a clean room.

### BRIEF DESCRIPTION OF THE DRAWINGS

FIG. 1 is a table showing a list of samples used in the Experimental Examples.

### DETAILED DESCRIPTION OF THE INVENTION

Antistatic sheet: The antistatic sheet of the present invention includes a base sheet and a polymer gel.

The polymer gel includes; a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; water having dissolved therein at least polyvinyl alcohol-type polymer; and a polyhydric alcohol other than polyvinyl alcohol-type polymer, wherein the water and the polyhydric alcohol are retained in the polymer matrix.

Examples of polymerizable monomers used for forming the polymer matrix include acrylamide monomers such as (meth)acrylamide, N-methyl (meth)acrylamide, N-ethyl (meth)acrylamide, N-propyl(meth) acrylamide, N,N-dimethyl (meth)acrylamide, N,N-diethyl (meth)acrylamide, and N-isopropylacrylamide; water-soluble acrylic esters such as polyethylene glycol (meth)acrylate; vinyl amide monomers such as vinyl pyrrolidone, vinyl acetamide and vinylformamide; and nonionic monomers such as allyl alcohol. Further examples include (meth)acrylic acid or salts thereof, sulfonic acid group-containing anionic monomers such as tert-butylacrylamidesulfonic acid or salts thereof, and amino group- or ammonium group-containing cationic monomers such as dimethylaminomethylpropyl (meth)acrylamide. These monomers may be used individually or in any combination.

Among the polymerizable monomers exemplified above, those which are soluble in water are preferable since water is needed to dissolve polyvinyl alcohol-type polymers described below, and acrylamide monomers or water-soluble acrylic esters are more preferable since such monomers have excellent polymerization reactivity. Even more preferred are acrylamide monomers due to their excellent compatibility with other components of the polymer gel.

The concentration of the polymerizable monomer is preferably 13 parts by weight to 30 parts by weight, relative to 100 parts by weight of the total of the polymer gel. When the polymer gel is produced with the polymerizable monomer concentration of less than 13 parts by weight, the concentration of the polymer matrix in the gel is low so that a polymer gel having a sufficiently high stiffness (nerve) cannot be obtained. The resulting polymer gel is likely to be torn off when detached from an adherend and, therefore, is likely to leave a residual gel adhered to the surface of the adherend. On the other hand, when the polymerizable monomer concentration exceeds 30 parts by weight, the stiffness (nerve) of the polymer gel increases; however, not only is the flexibility of the gel sacrificed but the gel becomes brittle so that gel debris are likely to be attached to the base material as contaminant.

The crosslinkable monomer are not particularly limited as long as it is a monomer having in its molecule at least two polymerizable carbon-carbon double bonds. Preferred examples include acrylamide type monomers and polyfunctional monomers, such as N, N′-methylene bis(meth)acrylamide, N, N′-ethylenebis(meth)acrylamide, ethylene glycol di(meth)acrylate, glycerol tri(meth)acrylate, polyethylene glycol di(meth)acrylate, polypropylene glycol di(meth)acrylate, poly(glycerol di(meth)acrylate)

The concentration of the crosslinkable monomer is preferably 0.001 part by weight to 1.0 part by weight, more preferably 0.01 part by weight to 0.5 part by weight, relative to 100 parts by weight of the total of the polymer gel. When the crosslinkable monomer concentration exceeds 1.0 part by weight, the crosslink density of the polymer matrix becomes too high. As a result, while the stiffness (nerve) of the polymer gel increases, the gel becomes brittle so that gel debris are likely to be attached to the adherend as contaminant. On the other hand, when the crosslinkable monomer concentration is less than 0.001 part by weight, the crosslink density becomes too low, so that it becomes difficult to obtain a gelled polymer.

The polyvinyl alcohol type polymer is added for improving adhesive property of the antistatic sheet while preventing occurrence of tear or residual gel as well. The specific reason for addition of the polyvinyl alcohol type polymer is that, when only adjustment of the contents of the polymerizable monomer and the crosslinkable monomer is implemented, the resulting polymer gel may not have sufficient adhesive property or may become hard and brittle, while the problem of occurrence of tear or residual gel remains unsolved. The reason for such effect available by the addition of the polyvinyl alcohol type polymer is presumed that the polyvinyl alcohol type polymer penetrates through the polymer matrix crosslinked with the polymerizable monomer and the crosslinkable monomer so as to form a gel structure called S-IPN (Semi-Interpenetrating Polymer Network).

Further, the retention of water having dissolved therein the polyvinyl alcohol type polymer within the polymer matrix enables to obtain an effect that the loss of water by drying of the polymer gel can be suppressed and the antistatic effect can be maintained over time.

As to the polymerization degree of the polyvinyl alcohol type polymer, it is preferable that the polymer has a viscosity average molecular weight of 500 to 3,000. When the polymerization degree is less than 500 in terms of the viscosity average molecular weight, the mechanical strength of the antistatic film is unlikely to improve satisfactorily. On the other hand, when the polymerization degree exceeds 3,000, the viscosity of the polymer increases during the dissolution thereof such that a uniformly blended monomer solution is unlikely to be obtained.

The polyvinyl alcohol type polymer preferably has a saponification degree of 80 to 98%. When the saponification degree is less than 80%, the solubility of the polymer at the preparation of the monomer blend solution improves; however, the stability of the resulting polymer gel is likely to become poor. On the other hand, when the saponification degree exceeds 98%, the solubility of the polymer becomes poor so that the preparation of the monomer blend solution becomes difficult.

The amount of the polyvinyl alcohol type polymer is preferably 0.15 part by weight to 30 parts by weight, relative to 100 parts by weight of the polymer matrix in which the polymerizable monomer and the crosslinkable monomer are copolymerization-crosslinked. When the amount of the polyvinyl alcohol type polymer is less than 0.15 part by weight, the mechanical strength of the antistatic film is unlikely to improve satisfactorily. On the other hand, when the amount exceeds 30 parts by weight, the solubility of the polyvinyl alcohol type polymer becomes poor such that a uniform polymer gel is unlikely to be obtained.

Examples of the polyvinyl alcohol type polymer include polyvinyl alcohol, an ethylene-polyvinyl alcohol copolymer, derivatives of polyvinyl alcohol, and a modified polyvinyl alcohol.

The polyvinyl alcohol type polymer is preferably constituted of linear polymer molecules. This is because the S-IPN structure can be easily obtained.

The amount of water contained in the polymer gel is preferably 40 to 460 parts by weight, relative to 100 parts by weight of the polymer matrix. When the amount of water is less than 40 parts by weight, the dissolution of the polyvinyl alcohol type polymer may become difficult. On the other hand, when the amount of water exceeds 460 parts by weight, the dissolution of the polyvinyl alcohol is easy; however, the amount of water is likely to surpass the amount of water that can be retained by the polymer matrix so that the resulting product becomes susceptible to change in property by drying.

For improving the moisture retention property and plasticity, the antistatic sheet also contains a polyhydric alcohol in addition to the aforementioned polyvinyl alcohol type polymer. Examples of the polyhydric alcohol include diols such as ethylene glycol, propylene glycol, and butanediol; polyhydric alcohols such as glycerol, pentaerythritol, and sorbitol; polyhydric alcohol condensates such as polyethylene glycol, polypropylene glycol, poly-glycerin, and polypropylene oxide; and modified polyhydric alcohols such as polyoxyethylene glycerin, and polyoxypropylene polyglycerol ethers. Preferred are polyhydric alcohols which are in a liquid state at room temperature, more specifically, within a temperature range for actual use of the polymer gel (e.g., around 20° C. when the polymer gel is used in a room).

The concentration of the polyhydric alcohol is preferably 580 parts by weight or less, relative to 100 parts by weight of the polymer matrix. The concentration of the polyhydric alcohol is more preferably 100 parts by weight to 580 parts by weight because it becomes possible to impart the resulting polymer gel with a moisture retention property and suppress the unintended modification of properties by drying, so that the flexibility and antistatic property which are inherently possessed by the polymer gel can be exhibited for a longer period of time. When the concentration of the polyhydric alcohol exceeds 580 parts by weight, the water content of the polymer gel relatively becomes low so that the dissolution of the polyvinyl alcohol type polymer into the polymer gel becomes difficult and a polymer gel with high strength is unlikely to be obtained.

The polymerization initiator is not particularly limited. When the polymerization-crosslinking is performed by heating, an azo-polymerization initiator such as azobis(cyanovaleric acid) or azobis(amidinopropane)dihydrochloride can be used. Alternatively, when the polymerization is performed by photoirradiation, any of conventional photopolymerization initiators represented by azo-type initiators and acetophenone-type initiators can be used. Further, the polymerization may be performed by simultaneous application of photoirradiation and heating in the presence of a mixture of two or more of the aforementioned polymerization initiators.

Alternatively, it is also possible to use, for example, redox polymerization initiators comprising a reducing agent such as ferrous sulfate or a pyrosulfite, and a peroxide such as hydrogen peroxide or persulfate. When such redox polymerization initiators are used, the reaction can be implemented even without heating; however, it is preferred to implement the reaction while heating for reducing the residual monomers and reducing the reaction time.

If necessary, the polymer gel may contain any of various conventional additives. Examples of the additives include antioxidants, stabilizers, pH adjusters, aromatizers, colorants and dyes.

As an example of a method for producing the polymer gel, there can be mentioned the following method.

A polymerizable monomer having in its molecule at least one polymerizable carbon-carbon double bond, a crosslinkable monomer having in its molecule at least two polymerizable carbon-carbon double bonds, a polyvinyl alcohol-type polymer, water, a polyhydric alcohol other than polyvinyl alcohol-type polymer and, if necessary, a polymerization initiator or an additive are uniformly mixed and dissolved, to thereby obtain a monomer blend solution. Then, the polymerizable monomer and the crosslinkable monomer are polymerization-crosslinked to obtain the polymer gel. Since the monomer blend solution is a liquid, a polymer gel having a desired shape can be obtained by, for example, pouring the monomer blend solution into a resin mold etc. where the polymerization-crosslinking reaction is implemented. Further, when the monomer blend solution is poured into a gap between two films held with a predetermined interval therebetween, and a polymerization-crosslinking reaction is implemented, a polymer gel of a sheet shape can be obtained.

Example of a method for polymerization-crosslinking the polymerizable monomer and the crosslinkable monomer include a method involving heating or photoirradiation, and a method involving irradiation of electron beam, gamma ray, etc. However, the latter method involving irradiation requires a special facility for irradiation; therefore, the former method involving heating or photoirradiation is more preferable. When such method is employed, the production process is simple and the continuous production is possible; therefore, a very high economical advantage is available and a polymer gel with the same properties can be stably obtained.

The adhesive property of the polymer gel can be evaluated in terms of a gripping force in a horizontal direction relative to SUS and a stress at the time of peeling at a 90° angle, which is a peel strength for peeling from SUS.

The gripping force in a horizontal direction relative to SUS can be measured by a method in which the polymer gel cut into a strip having a size of 20 mm×120 mm is attached to SUS; the polymer gel is attached to a jig provided with a pulley and a weight; and the load imposed on the polymer gel in a horizontal direction is measured. Here, with the self-weight of a 5 N weight hung from the polymer gel, the polymer gel is pulled horizontally in a direction perpendicular to the 20 mm-width direction, and whether or not the polymer gel is displaced after being pulled for 30 minutes is checked. When (8 the polymer gel is not displaced, the polymer gel is judged to have a gripping force of 5 N/(20 mm×120 mm) or more, and when the polymer gel is displaced, the polymer gel is judged to have a gripping force of less than 5 N/(20 mm×120 mm).

The gripping force in a horizontal direction relative to SUS is preferably 5 N/(20 mm×120 mm) or more. When the gripping force is less than 5 N/(20 mm×120 mm), the antistatic sheet placed on an adherend such as a working platform is likely to move so that the working efficiency may deteriorate.

Further, the stress at the time of peeling at a 90° angle (peel strength for peeling from SUS) is evaluated in terms of the maximum stress at the time of peeling the polymer gel adhered to SUS with a strip-form area of 20 mm×120 mm from the SUS, wherein the peeling is conducted at a 90° angle from the end of the 20 mm width of the strip-form area with a peeling rate of 300 mm/min. This value is preferably 1 N/20 mm or less, and the lower limit is preferably 0.05 N/20 mm.

As to the electric property of the polymer gel, it is preferred that the surface resistivity of the polymer gel is 1.0×10³Ω/□ or more and less than 1.0×10⁹Ω/□. When the surface resistivity is within the range of 1.0×10³Ω/□ or more and less than 1.0×10⁹Ω/□, the standard of the IEC (International Electrotechnical Commission) can be met.

The thickness of the polymer gel may be 0.01 mm to 5.00 mm. As the thickness of the polymer gel increases, the cushioning effect tends to increase and the resistance to ground tends to decrease.

The base sheet is a part for carrying the polymer gel thereon and for maintaining the shape of the antistatic sheet to improve the handling property of the antistatic sheet.

As the base sheet, it is preferred to use a resin film because the polymer gel can be reinforced and the antistatic sheet can be maintained to be in a tape shape. Examples of the resin film include films of resins such as a polyester, a polyolefin, a polystyrene and a polyurethane. More preferable resin films include biaxially oriented PET film and PE film.

Examples of method for antistatic treatment of the base sheet include a method in which an antistatic agent or a conductive polymer is sprayed onto the surface of a resin film to form an antistatic layer thereon, a method in which an antistatic agent is blended into a resin or conductive particles and the like are kneaded into a resin during the formation of a reins film, and a method in which a conductive polymer is polymerized with the base material of the base sheet. Among the base sheets obtainable by such methods, it is preferred to use the base sheet with its surface antistatic treated. This is because the kneading method is considered to cause a harmful influence due to electro-static discharge by local potential ascribed to, for example, poor distribution of the conductive particles and the like, whereas the surface treatment by the formation of an antistatic layer enables uniform antistatic treatment, thereby reducing the risk of causing a local potential difference.

Examples of the antistatic agents include various surfactants of anionic, nonionic, cationic and amphoteric types; carbon: and metal oxides.

Examples of the conductive polymers include those of polyaniline, polypyrrole and polythiophene types. Further, as the antistatic treated base sheet, it is possible to use a commercially available sheet which has already been antistatic treated by the method as mentioned above.

As to the antistatic performance of the base sheet, it is preferred that the surface resistivity of the base sheet is 1×10⁴Ω/□ or more and less than 1×10⁹Ω/□. The surface resistivity within this range is effective for preventing the antistatic sheet, when removed from an adherend, from being electrically charged, thereby keeping the products away from dust, and for preventing the electronic parts from being harmfully influenced by too low a resistance.

The thickness of the base sheet can be appropriately selected in view of a site at which the antistatic sheet is used, and may be in the range of 10 μm to 200 μm. For the purpose of reducing the ground resistance, the base sheet is preferred to have a smaller thickness. A desired ground resistance can be achieved by controlling the thickness of the base film. Further, the base film becomes harder and more rigid as the thickness thereof increases. When the base film is required to be flexible, it is preferred to use a film made of a soft material such as a PE film, or to use a thin film. When the base film is required to be rigid, it is preferred to use a film made of a rigid material such as a PET film, or to use a thick film.

The base film is preferably transparent or white. When the base film is transparent, an operation can be performed even from above the antistatic film attached to a touch panel such as an operation board, or a simplification of an instruction sheet, a positioning, etc. is possible in the case of the use of the antistatic film on a working platform. When the base film is white, stains can be clearly observed which, for example, can be utilized for determining the time for changing the antistatic sheet, and a comely and pleasant appearance can be given.

The ground resistance of the antistatic sheet which is a combination of the polymer gel and the base sheet may be 1×10⁵Ω or more and 1×10¹²Ω or less, and preferably 1×10⁵Ω or more and less than 1×10⁹Ω. The ground resistance in the range of 1.0×10⁵Ω or more and 1.0×10¹²Ω or less is a value required in various situations where countermeasures against static electricity are required, and the ground resistance in the range of 1.0×10⁵Ω or more and less than 1.0×10⁹Ω meets the standard of the IEC (International Electrotechnical Commission).

The surface resistivity of the antistatic sheet, which is a combination of the polymer gel and the base sheet, as measured with respect to a surface thereof on a side of the base sheet may be 1×10⁴Ω/□ or more and 1×10¹²Ω/□ or less, and preferably 1×10⁴Ω/□ or more and less than 1×10⁹Ω/□. The surface resistivity in the range of 1.0×10⁴Ω/□ or more and 1.0×10¹²Ω/□ or less is a value required in various situations where countermeasures against static electricity are required, and the surface resistivity in the range of 1.0×10⁴Ω/□ or more and less than 1.0×10⁹Ω/□ meets the standard of the IEC (International Electrotechnical Commission).

As an example of a method for producing the antistatic sheet, there can be mentioned the following method.

A monomer blend solution prior to polymerization to form a polymer gel is prepared, and the solution (composition) is poured into a mold having a predetermined shape, followed by polymerization to obtain a polymer gel. The obtained polymer gel and the base sheet are unified by, for example, placing the polymer gel on the base sheet or binding the base sheet to the polymer gel. Thus, the antistatic sheet can be obtained.

Alternatively, the antistatic sheet can be produced by a method in which a monomer blend solution prior to polymerization to form a polymer gel is applied onto the base sheet, followed by polymerization while maintaining the thickness of the polymer gel at a predetermined level. As still another method for producing the antistatic sheet, there can be mentioned a method in which the monomer blend solution is poured into a gap between the base sheet and another sheet which are retained with a predetermined interval therebetween, followed by polymerization.

The aforementioned antistatic sheet has excellent antistatic performance, and can be easily attached to and removed from an adherend such as a working platform in a clean room.

### EXAMPLES

Hereinbelow, the present invention will be described in more detail with reference to the Examples.

### Experimental Example 1

To a mixture of 24 parts by weight of acrylamide as the polymerizable monomer, 0.3 part by weight of N, N′-methylenebisacrylamide as the crosslinkable monomer, 45 parts by weight of glycerol which is a polyhydric alcohol as a wetting agent, and 3 parts by weight of polyvinyl alcohol with a viscosity average polymerization degree of 1,800 and a saponification degree of 88% was added water as a solvent in an amount such that the total amount of the resulting mixture became 99.8 parts by weight, followed by stirring to obtain a solution. Then, as a photopolymerization initiator, 0.2 part by weight of 1-[4-(2-hydroxyethoxy)-phenyl]-2-hydroxy-2-methyl-propan-1-one (“IRUGACURE2959 (trade name)” manufactured by BASF Japan Ltd.) was added to the obtained 99.8 parts by weight of the solution (composition), followed by stirring to obtain a monomer blend solution. The obtained monomer blend solution was thinly coated onto an untreated surface of a 100 μm-thick transparent polyethylene terephthalate film (base sheet) having one surface thereof antistatic-treated by coating with an antistatic agent (“NAS-PET (trade name)” manufactured by Nagaoka Sangyou Co., Ltd.,), wherein the untreated surface is opposite to the antistatic-treated surface. The coating of the monomer blend solution was covered with a 38 μm-thick silicone-coated polyethylene terephthalate film (separator). Then, the resultant structure was fixed such that the polymer blend solution was caused to uniformly expand between the films so as to obtain a polymer gel layer having a thickness of 0.3 mm. Using a metal halide lamp, the resultant was irradiated with ultraviolet light having an energy of 2,000 mJ/cm² using a metal halide lamp to perform a polymerization-crosslinking reaction, thereby obtaining a temporary fixing material (sample 1) having the base material on one side and the separator attached on the other side, and having a thickness of 438 μm.

### Experimental Examples 2 to 10

In Experimental Examples 2 to 10, the monomer blend solutions having respective compositions as shown in Table 1 were used instead of the monomer blend solution used in Experimental Example 1. Further, in Experimental Example 5, a white polyethylene terephthalate film (White PET, manufactured by Nagaoka Sangyou Co., Ltd.,) was used; in Experimental Example 6, the thickness of the polymer gel was 1,000 μm; in Experimental Example 8, the thickness of the base sheet was 38 μm; in Experimental Example 9, a polyethylene film having a thickness of 60 μm was used; and in Experimental Example 10, a slightly black transparent polyethylene terephthalate film into which an antistatic agent had been kneaded (“MK-APT (trade name)” which is an antistatic transparent tape for clean room, manufactured by Tanimura Corp.). Otherwise, antistatic sheets as sample 2 to 10 were produced in the same manner as in Experimental Example 1.

### Experimental Examples 11 and 12

In Experimental Example 11, an adhesive tape in which an acrylic adhesive is laminated on an antistatic-treated base sheet was used instead of the antistatic sheet of Experimental Example 1. Further, in Experimental Example 12, a silicone gel was used instead of the polymer gel obtained in Experimental Example 1 by polymerization-crosslinking reaction of the monomer blend solution, and the silicone gel was attached to the same base sheet as used in Experimental Example 1. Thus, antistatic sheets as samples 11 and 12 were obtained. Here, an adhesive sheet 6671 #25 (manufactured by Teraoka Seisakusho Co., Ltd.) was used as the adhesive tape for sample 11, and Gel film 0 (manufactured by Gel-Pak, Inc.) was used as the silicone gel for sample 12.

### Experimental Example 13

In Experimental Example 13, a commercially available antistatic sheet, Achilles Seiden Crystal (manufactured by Achilles Corporation), was used instead of the adhesive sheet of Experimental Example 1. The total thickness of the antistatic sheet was 2,000 μm, and the sheet was transparent and had a surface resistivity of 1×10¹⁰Ω/□; however, the sheet had no adhesion nor gripping force relative to the SUS. The sheet could be easily removed, but there was a gap between the sheet and the SUS so that the ground resistance was unstable.

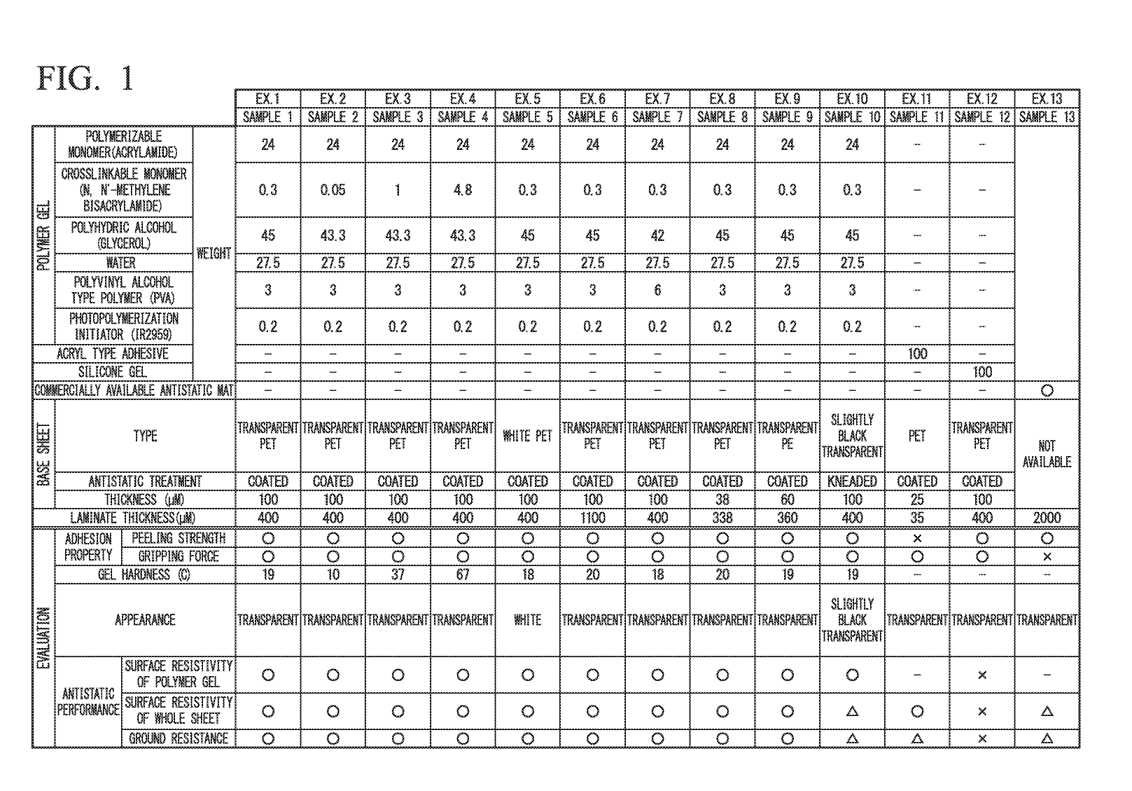

The respective compositions of samples 1 to 13 obtained in Experimental Examples 1 to 13 are shown in the list of FIG. 1. In the list (FIG. 1), the amounts are expressed in terms of part by weight with respect to the composition of the polymer gel, the acrylic adhesive of the adhesive tape and the silicone gel.

### [Performance Evaluation Method]

With respect to each of the samples 1 to 13 (antistatic sheets) obtained in the aforementioned Experimental Examples 1 to 13, the antistatic performance, adhesive property, gel hardness and appearance were evaluated by the following measurements and observations. The results are also shown in Table 1.

### (1) Adhesive Property

The adhesive property was evaluated with respect to the polymer gel constituting each sample (or a part other than the base sheet in the case of a sample where a polymer gel was not used), based on the results of the measurements of the peel strength for peeling from SUS and the gripping force in a horizontal direction relative to SUS. That is, a polymer gel was prepared which had the same thickness as that of a product obtained by removing the base sheet from each sample, and subjected to the following experiments.

i) Peel Strength for Peeling from SUS (Stress at the Time of Peeling at a 90° Angle)

Each sample was cut into a piece of 20 mm in width and 120 mm in length, followed by removal of the polyethylene terephthalate film as the separator, to obtain a test piece composed of the base sheet and the polymer gel. Then, the obtained test piece was attached, on its polymer gel side, to an adherend that was a SUS 304 grade stainless steel mirror-finished with #800, and a pressing roller of 2 kg was reciprocated once on the resulting laminate, thereby pressure-bonding the test piece to the adherend. An end of the test piece (the short side) was fixed with a chuck, and the stress at the time of peeling at a 90° angle (peel strength) (N/20 mm) was measured using a TENSILON universal testing machine (“RTE-1210 (trade name)” manufactured by Orientec Corporation) at a temperature of 23±5° C., a humidity of 55±10% and a test speed of 300 mm/min. The results were evaluated in terms of the following classifications: “∘” when the peel strength was 0.1 N/20 mm or more and 1.0 N/20 mm or less, and “x” when the peel strength was less than 0.1/20 mm or more than 1.0 N/20 mm.

### ii) Gripping Force in a Horizontal Direction Relative to SUS:

With respect to each of the samples, the polymer gel attached to the base sheet was cut into a strip having a size of 20 mm×130 mm, and bonded to a SUS 304 grade stainless steel (SUS) with an area of 20 mm×120 mm. Then, an end of the 20 mm×10 mm portion of the polymer gel, which was not bonded to the SUS, was held by a clip, and a wire extending in a horizontal direction from the clip was passed through a pulley and attached to a weight hung downwardly so that a tensile load of 5 N was applied horizontally to the contact surface between the SUS and the antistatic sheet. After maintaining this state for 30 minutes, whether or not the polymer gel on the SUS was displaced was checked, and the results were evaluated in terms of the following classifications: “∘” when the polymer gel was not displaced and the gripping force of 5 N/(20 mm×120 mm) was confirmed, and “x” when the polymer gel was displaced and such a gripping force was not achieved.

### (2) Gel Hardness of the Polymer Gel

The polymer gel of each sample was shaped into a test piece having a size of 44 mm (width)×18 mm (depth)×10 mm (thickness) or larger. Then, using a rubber hardness tester (ASKER Durometer Type C), the hardness value at 1 minute after the application of a load of 1 kg to the test piece was read.

The results were evaluated in terms of the following classifications: “∘” when the hardness was 5 to 80, and “x” when the hardness was less than 5 or more than 80.

With respect to each of the samples 11 to 13, the adhesion property and the antistatic performance were so poor that the measurements and evaluations were omitted.

### (3) Appearance

The appearance of each sample was visually observed from the side of the base sheet. The results were evaluated in terms of the following classifications: “Transparent” when the opposite side of the sample could be seen, and “White” when the sample was white and opaque. That is, the “Transparent” is not limited to the case where the sample was colorless transparent but also includes the case where the sample was colored transparent, e.g., white transparent.

### (4) Antistatic Performance

The antistatic performance was evaluated based on the surface resistivity (Ω/□) measured solely on the polymer gel, the surface resistivity (Ω/□) measured on the base sheet side of each sample, and the ground resistance (Ω) measured with respect to each sample.

iii) Surface Resistivity of Polymer Gel

Each sample was cut into a piece having an area of at least 100 mm×100 mm, and the surface resistivity (Ω/□) was measured on the polymer gel after removal of the polyethylene terephthalate film as separator, using a surface resistance meter (main body: Model-152, probe: 152P-CR, manufactured by Trek Japan Co. Ltd.) The conditions for the measurement were: a temperature of 23±5° C., and a humidity of 55±10%. The results were evaluated in terms of the following classifications: “∘” when the surface resistivity was 1.0×10³Ω/□ or more and less than 1.0×10⁹Ω/□, “x” when the surface resistivity was more than 1.0×10¹²Ω/□, and “Δ” when the surface resistivity was less than 1.0×10³Ω/□ or when the surface resistivity was 1.0×10⁹Ω/□ or more and 1.0×10¹²Ω/□ or less. The reason for classification “Δ” is that the antistatic performance is satisfactory but the surface resistivity is low such that the electronic parts may be harmfully influenced or satisfactory ESD characteristics may not be obtained in the case of electronic appliances requiring a high level of static electricity removal. With respect to each of the samples 11 and 13, the adhesion property was so poor that the measurements and evaluations were omitted.

### iv) Surface Resistivity of Antistatic Sheet

Each sample was cut into a piece having an area of at least 100 mm×100 mm, and the surface resistivity (Ω/□) was measured on the sample with the PET surface, using a surface resistance meter (main body: Model-152, probe: 152P-CR, manufactured by Trek Japan Co. Ltd.) The conditions for the measurement were: a temperature of 23±5° C., and a humidity of 55±10%. The results were evaluated in terms of the following classifications: “∘” when the surface resistivity was 1.0×10⁴Ω/□ or more and less than 1.0×10⁹Ω/□, “x” when the surface resistivity was more than 1.0×10⁹Ω/□, and “Δ” when the surface resistivity was less than 1.0×10⁴Ω/□. The reason for classification “Δ” is that the antistatic performance is satisfactory but the surface resistivity is low such that the electronic parts may be harmfully influenced.

### v) Ground Resistance of Antistatic Sheet

The ground resistance of each sample was measured as follows.

A sample having an area of 200 mm in width and 200 mm in length was prepared and bonded to SUS (300 mm×400 mm) so that the polymer gel contacts the SUS. A resistance meter (main body: Model-152, probe: 152AP-5P, manufactured by Trek Japan Co. Ltd.) was attached to each of the base sheet and the SUS, so that the distance between two electrodes in a horizontal direction was 30 cm, to thereby measure the ground resistance (point-to-point resistance) with a distance of 30 cm. The conditions for the measurement were: a temperature of 23±5° C., and a humidity of 55±10%. The results were evaluated in terms of the following classifications: “∘” when the ground resistance was 1.0×10⁵Ω or more and less than 1.0×10⁹Ω, “Δ” when the ground resistance was 1.0×10⁹Ω or more and 1.0×10¹²Ω or less, and “x” when the ground resistance was less than 1.0×10⁵Ω or more than 1.0×10¹²Ω.

### [Results of Performance Evaluation]

The results of the performance evaluation of each sample were as shown in Table 1, based on which the following observations were made.

The antistatic sheets of samples 1 to 9 were all excellent in respect of the adhesive property and the antistatic performance. On the other hand, with respect to sample 10 in which the antistatic agent had been kneaded into the resin used in the base sheet, the surface resistivity and the ground resistivity as criteria for the antistatic performance exceeded 1×10⁹Ω/□ and 1×10⁹Ω respectively, which means that sample 10 is slightly inferior in antistatic performance to samples 1 to 9.

Further, sample 11 using an adhesive tape comprising an acrylic adhesive instead of the polymer gel had a peel strength exceeding 5 N/20 mm and, therefore, was hard to remove, which means that sample 11 had a poor removability. Sample 12 using a silicone gel instead of the polymer gel had a surface resistivity exceeding 1.0×10¹²Ω/□, which means that sample 12 had a poor antistatic performance. Sample 13 was inferior in respect of the gripping force and the antistatic performance.

1. An antistatic sheet comprising a laminated body formed by laminating a polymer gel on a base sheet subjected to antistatic treatment,
the polymer gel comprising: a polymer matrix obtained by copolymerization-crosslinking of a polymerizable monomer having in its molecule at least one polymerizable carbon-carbon double bond and a crosslinkable monomer having in its molecule at least two polymerizable carbon-carbon double bonds; water having dissolved therein at least polyvinyl alcohol-type polymer; and a polyhydric alcohol other than polyvinyl alcohol-type polymer, wherein the water and the polyhydric alcohol are retained in the polymer matrix,
the antistatic sheet having a ground resistance of 1.0×10⁵Ω or more and 1.0×10¹² fl or less, and a surface resistivity of 1.0×10⁴Ω/□ or more and 1.0×10¹²Ω/□ or less as measured with respect to a surface thereof on a side of the base sheet.

2. The antistatic sheet according to claim 1, which has a ground resistance of 1.0×10⁵Ω or more and less than 1.0×10⁹Ω, and a surface resistivity of 1.0×10⁴Ω/□ or more and less than 1.0×10⁹Ω/□.

3. The antistatic sheet according to claim 1, which is a laminated body formed by providing an antistatic coating on one side of the base sheet, and laminating a polymer gel on another side of the base sheet.

4. The antistatic sheet according to claim 1, wherein the polymer matrix of the polymer gel is an acrylic polymer, and a surface resistivity of the polymer gel is 1.0×10³Ω/□ or more and less than 1.0×10⁹Ω/□.

5. The antistatic sheet according to claim 1, wherein the polymer gel has a C-type hardness of 5 to 80, a gripping force in a horizontal direction relative to SUS is 5 N/(20 mm×120 mm) or more, and a peel strength for peeling from SUS is 1 N/20 mm or less.

6. The antistatic sheet according to claim 1, wherein the base sheet is a transparent or white sheet of an olefin-type.

7. The antistatic sheet according to claim 1, which is used as a tabletop sheet to be placed on top of a working platform or a conveying stand in a clean room requiring a countermeasure against static electricity.
